(19) United States
(12) Patent Application Publication
(10) Pub. No.: US 2026/0148265 A1
(43) Pub. Date: May 28, 2026

(54) SYSTEMS AND METHODS FOR CONTROLLING RATING INFORMATION IN EMPLOYMENT PLATFORMS

(71) Applicant: Yvonne L. Smith, Frederick, MD (US)

(72) Inventor: Yvonne L. Smith, Frederick, MD (US)

(21) Appl. No.: 19/395,099

(22) Filed: Nov. 20, 2025

Related U.S. Application Data
(60) Provisional application No. 63/724,752, filed on Nov. 25, 2024.

(51) Int. Cl. G06Q 30/0282; G06F 3/0482

(52) U.S. Cl. CPC G06Q 30/0282; G06F 3/0482

(57) ABSTRACT

A system for controlling notifications relating to rating information, may include one or more processors and memory. The one or more processors may receive a first value input by a first user at a first time point, and determine a first rating of performance of a third user using the first value and the first time point. The one or more processors may receive a second value input by a second user at a second time point later than the first time point, and determine a second rating of the performance of the third user using the first value, the first time point, the second value and the second time point. The one or more processors may determine a difference between the first rating and the second rating, and send a first notification to at least one of the first user, the second user or the third user.

### CROSS-REFERENCE TO RELATED APPLICATIONS

This application claims the benefit of and priority to U.S. Provisional Application No. 63/724,752, filed on Nov. 25, 2024, which is incorporated herein by reference in its entirety for all purposes.

### TECHNICAL FIELD

The present disclosure relates to systems and methods for controlling rating information and more particularly to systems and methods for receiving rating information of a user and controlling notification relating to the rating information.

### BACKGROUND

Current rating platforms often use static or less dynamic rating systems, e.g., the rating does not likely change dynamically. For example, a job matching platform may use ratings for employers or job seekers (e.g., laborers). This may make it challenging for users to recover from a low rating or for new users to establish credibility. In a job matching platform, improvements remain desired in a rating system for promoting trust and transparency between employers and job seekers, and encouraging high performance of the employers or job seekers.

### SUMMARY

Implementations of the present disclosure relate to a system and a method for controlling rating information and more particularly to systems and methods for receiving rating information of a user and controlling notification relating to the rating information.

In some implementations of the present disclosure, a system for controlling notifications relating to rating information, may include one or more processors and memory. The one or more processors may be configured to receive a first value input by a first user at a first time point, and determine a first rating of performance of a third user using the first value and the first time point. The one or more processors may be configured to receive a second value input by a second user at a second time point later than the first time point, and determine a second rating of the performance of the third user using the first value, the first time point, the second value and the second time point. The one or more processors may be configured to determine a difference between the first rating and the second rating, and send a first notification to at least one of the first user, the second user or the third user.

In some implementations of the present disclosure, a method for controlling notifications relating to rating information, may include receiving, by one or more processors, a first value input by a first user at a first time point, and determining a first rating of performance of a third user using the first value and the first time point. The method may include receiving, by the one or more processors, a second value input by a second user at a second time point later than the first time point, and determining a second rating of the performance of the third user using the first value, the first time point, the second value and the second time point. The method may include determining, by the one or more processors, a difference between the first rating and the second rating, and sending a first notification to at least one of the first user, the second user or the third user.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 is a block diagram illustrating an example of a system environment for a rating control system according to some implementations.

FIG. 2 is a block diagram illustrating an example of a computing system according to some implementations.

FIG. 3 is an example user interface for logging into an employment platform according to some implementations.

FIG. 4 is an example user interface for creating a job card (e.g., job announcement, job post, recruiting card, recruiting announcement, recruiting post) according to some implementations.

FIG. 5 is an example user interface for displaying performance of an employer (e.g., a company) based on reviews of the company by an employee (e.g., day laborers), according to some implementations.

FIG. 6 is an example user interface for searching for a day laborer, according to some implementations.

FIG. 7 is an example user interface for displaying information of a hired day laborer, according to some implementations.

FIG. 8 is an example user interface for writing and submitting a review of a day laborer, according to some implementations.

FIG. 9 is an example user interface for displaying information of a day laborer, according to some implementations.

FIG. 10 is an example user interface for displaying performance of a day laborer based on reviews of the day laborer by employers, according to some implementations.

FIG. 11 is an example user interface for searching for a job, according to some implementations.

FIG. 12 is an example user interface for displaying information of an employer and one or more jobs posted by the employer, according to some implementations.

FIG. 13 is an example user interface for writing and submitting a review of an employer, according to some implementations.

FIG. 14 is an example user interface 1400 for displaying one or more jobs completed by a day laborer and documentation on the day laborer, according to some implementations.

FIG. 15 is a flowchart illustrating an example methodology for controlling notifications relating to rating information according to some implementations.

### DETAILED DESCRIPTION

According to certain aspects, implementations in the present disclosure relate to a system and a method for controlling rating information and more particularly to systems and methods for receiving rating information of a user and controlling notification relating to the rating information.

Current rating platforms often use static or less dynamic rating systems, e.g., the rating does not likely change dynamically because users' ratings are either cumulative over time or overly reliant on old reviews. For example, a job matching platform may use ratings for employers or job seekers (e.g., laborers). This may make it challenging for users to recover from a low rating or for new users to establish credibility. In a job matching platform, improvements remain desired in a rating system for promoting trust and transparency between employers and job seekers, and encouraging high performance of the employers or job seekers.

To solve the above-noted problems, according to certain aspects, a rating control system can provide a fair and balanced rating system where every user starts with a rating (e.g., 5-star rating) such that ratings can fluctuate based on recent feedback. In some implementations, in employment platforms, a dynamic rating system (e.g., 5-star rating system) can allow employers and job seekers (e.g., day laborers) to receive real-time feedback that can increase or decrease their initial rating based on job performance and user reviews.

In some implementations, a rating control system (also referred to as “rating system” or “rating management system”) can provide a dynamic rating system or mechanism for a mobile employment platform where both employers and day laborers can begin with a default 5-star rating. The system can allow ratings to fluctuate based on user reviews, job performance and interactions, with the capability to increase, decrease, or maintain the initial rating. The rating system can encourage accountability, trust, and transparency between employers and laborers.

In some implementations, the rating system can incorporate a feedback mechanism that allows users to provide detailed reviews. The rating system can dynamically adjust the rating and incorporate thresholds and penalties for low ratings, while also offering mechanisms to improve ratings over time. In some implementations, the rating system can dynamically adjust a rating (e.g. a 5-star rating) of employers and job seekers (e.g., day laborers) in an application employment platform.

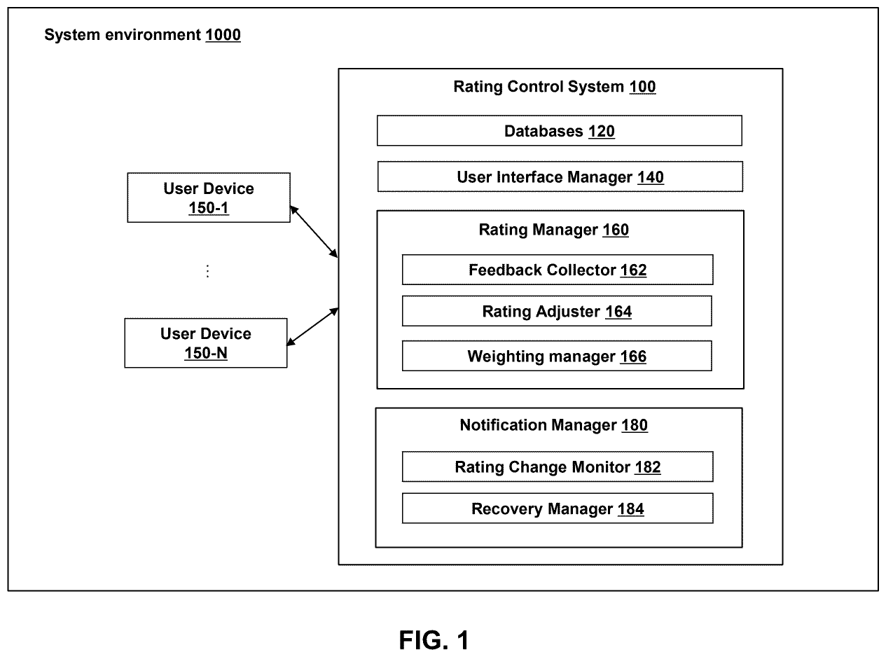

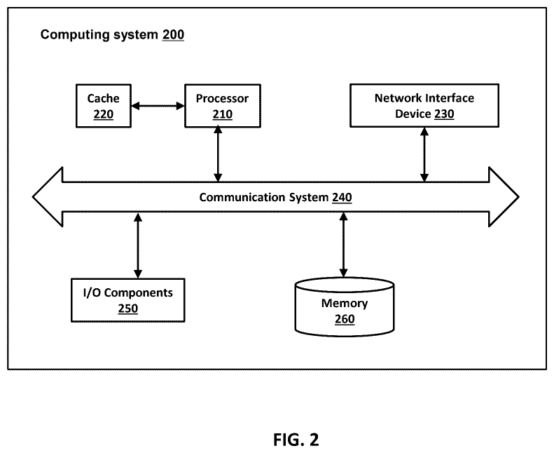

FIG. 1 is a block diagram illustrating an example of a system environment 1000 for a rating control system 100 according to some implementations. Referring to FIG. 1, the system 100 may be a rating control system, a rating system, a job matching system, or an employment system, or an employment management system. The system 100 may be coupled or paired with a plurality of user devices 120-1 to 120-N. Each of the plurality of user devices may be used by one or more users. The one or more users may include one or more employers and/or one or more job seekers (e.g., day laborers). In some implementations, the system 100 may be connected to the plurality of user devices 120-1 to 120-N via a network. Here, the network may be a Local Area Network (“LAN”), a wide area network (“WAN”), a wireless network, and/or the Internet, among others. The wireless network may be the IEEE 802.11 protocols, near field communication (NFC), Bluetooth, ANT, or any other wireless protocol, among others. Each of the system 100 and the plurality of user devices 120-1 to 120-N may have configurations similar to those of computing system 200 in FIG. 2.

In some implementations, the system 100 may include a user interface manager 140 (e.g., user interface module), a rating manager 160 (e.g., a rating control module, a rating module), and/or a notification manager 180 (e.g., a notification module), which will be described in more details in the following sections. In some embodiments, at least one or more of the user interface manager 140, the rating manager 160, or the notification manager 180 may be implemented with a circuit (e.g., circuitry of a FPGA, CPU, GPU or other processing circuits implemented using electronic circuits), a subroutine in a program stored in memory (e.g., EPROM, EEPROM, SDRAM, and flash memory devices, CD ROM, DVD-ROM, or Blu-Ray® discs and the like) and executable by a processor (e.g., CPU, GPU and the like), or the like. The rating manager 160 may include a feedback collector 162 (e.g., feedback module or feedback collection module), a rating adjuster 164 (e.g., rating adjusting module, dynamic rating adjusting module, average calculation module, weight-based average calculation module, weight-based average module), and/or a weighting manager 166 (e.g., review weighting module, weighting module, weighting management module). The notification manager 180 may include a rating change monitor 182 (e.g., rating monitoring module, or rating change module) and/or a recovery manager 184 (e.g., recovery module).

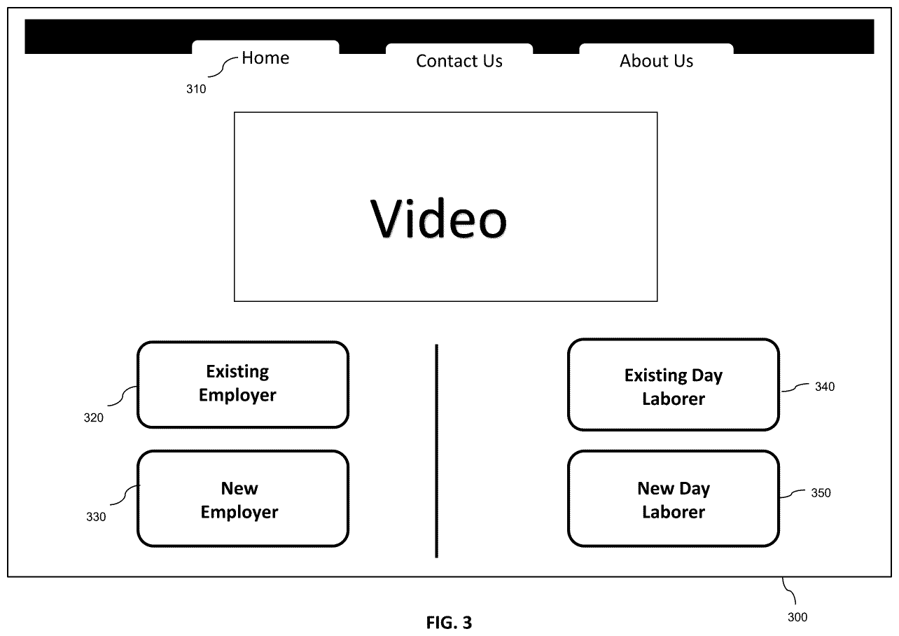

In some implementations, the system 100 may include one or more databases 120 to store data managed by one or more of the user interface manager 140, the rating manager 160, or the notification manager 180 (e.g., data relating to user interfaces, ratings, weights, reviews, employers, job seekers, job applications, photos or videos, notifications, etc.). In some implementations, the user interface manager 140 may generate user interfaces (e.g., graphical user interfaces shown in FIGS. 3-14) for displaying data or receiving input to perform functions of the rating manager 160 or the notification manager 180.

In some implementations, the rating manager 160 may perform a rating initialization to assign a default 5-star rating to both employers and day laborers upon registration. Upon registration (e.g., upon creating an account for a rating control system or a job matching platform), the rating manager 160 may give a default 5-star rating to (registered) users (e.g., both employers and day laborers). This initial rating can serve as a baseline, and every job interaction can affect the rating based on performance feedback.

In some implementations, the rating manager 160 (e.g., feedback collector 162) may allow users to rate the performance of an employer or a day laborer after completion of each job, with ratings submitted on a scale of 1 to 5 stars, for example. The feedback collector 162 can provide a detailed review feature that allows users to provide textual feedback in addition to their star rating, enabling more comprehensive performance evaluations. The feedback collector 162 can allow both employers and day laborers to submit a review after each job completion, ensuring that all users have a rating and feedback is consistently collected. In some implementations, the rating system can allow employers and day laborers to view each other's ratings before accepting a job or a candidate, ensuring that decisions are based on transparent performance history. The feedback collector 162 can allow, after completing a job, the employer and day laborer to rate each other using a 1 to 5-star system. The feedback collector 162 can allow users to leave textual feedback for more detailed reviews. The feedback collector 162 can use a user interface (e.g., user interface generated by the user interface manager 140) that is designed to be user-friendly, encouraging both parties to participate.

In some implementations, the rating manager 160 (e.g., rating adjuster 164) may calculate an average of submitted ratings and adjust the user's overall rating, allowing the rating to increase back to 5, decrease, or remain constant based on feedback. The rating manager 160 (e.g., weighting manager 166) may give more recent reviews a higher influence (or weight) on the overall rating than older reviews, ensuring a dynamic reflection of performance of an employer or a day laborer.

In some implementations, the rating manager 160 (e.g., rating adjuster 164) can perform rating adjustment and weighting as follows. The rating adjuster 164 can dynamically calculate the overall rating by averaging the reviews (e.g., each review with a scale of 1 to 5 stars). The rating manager 160 can allow recent reviews to carry more weight than older reviews to ensure that ratings reflect current or more recent performance. This can prevent a low rating from permanently harming a user's standing if they demonstrate improvement in later jobs.

In some implementations, the rating manager 160 (e.g., rating adjuster 164) can perform an algorithm for weighted rating calculation as follows. The rating adjuster 164 may receive input data including ratings and weights. In some implementations, the input ratings R1, R2, R3, . . . , Rn may be ratings received over time, where R1 is the oldest and Rn is the most recent rating. The input weights W1, W2, W3, . . . , Wn may be weights applied to each rating, where W1 is the weight for the oldest rating and Wn is the weight for the most recent rating.

In some implementations, the rating manager 160 (e.g., weighting manager 166) can perform weight calculation by assigning increasing weights to more recent ratings. In some implementations, the weighting manager 166 can assign weights to ratings using a linear weighting scale (e.g., more recent ratings are weighted higher) or an exponential decay model (e.g., more recent ratings are exponentially weighted higher). For example, with a linear weighting scale for 5 ratings, the weighting manager 166 can use W1=1, W2=2, W3=3, W4=4, W5=5. With an exponential weighting scale for 5 ratings, the weighting manager 166 can use W1=1, W2=2, W3=4, W4=8, W5=16.

In some implementations, the rating manager 160 (e.g., rating adjuster 164) can perform weighted average calculation to calculate the overall rating of a particular user. In some implementations, the rating adjuster 164 can calculate the overall rating using the following weighted average formula:

$$\frac{R 1 \times W 1 + R 2 \times W 2 + R 3 \times W 3 + R 4 \times W 4 + R 5 \times W 5}{W 1 + W 2 + W 3 + W 4 + W 5} \qquad ( Formula 1 )$$

This formula can allow more recent ratings to contribute more heavily to the overall rating, while still accounting for older ratings. For example, suppose a day laborer has 5 ratings: R1=3, R2=4, R3=5, R4=4, R5=5. When using a linear weight scale: W1=1, W2=2, W3=3, W4=4, W5=5, the overall rating can be calculated using Formula 1 as follows:

$$\frac{( 3 \times 1 ) + ( 4 \times 1 ) + ( 5 \times 3 ) + ( 4 \times 4 ) + ( 5 \times 5 )}{1 + 2 + 3 + 4 + 5} = \frac{67}{15} = 4.47$$

The overall rating would be 4.47, with more recent ratings (higher weights) having a greater influence.

In some implementations, the notification manager 180 (e.g., rating change monitor 182) may inform users when their rating changes after new feedback or review is submitted. In response to a new feedback or review of a particular user (e.g., a day laborer) being submitted by another user (e.g., an employer), the rating change monitor may check or determine whether a new rating calculated based on the new feedback or review (e.g., new rating calculated by the rating adjuster 164) satisfy a condition (e.g., below a predetermined threshold for a predetermined time duration or a predetermined number of recent reviews, or above a predetermined threshold for a predetermined time duration or a predetermined number of recent reviews). In response to determining that the new rating satisfies the condition, the notification manager 180 may send a notification (e.g., message) to one or more users including the particular user (e.g., the day laborer) or the other user (e.g., the employer). The notification may indicate a change of the new rating from the previous rating, the rating of the particular user consistently being below a predetermined threshold for a predetermined time duration or a predetermined number of recent reviews, or the rating of the particular user consistently being above a predetermined threshold for a predetermined time duration or a predetermined number of recent reviews.

In some implementations, the notification manager 180 (e.g., recovery manager 184) may execute a recovery mechanism that allows users with low ratings to improve their scores through positive performance in subsequent jobs. The recovery manager 184 may perform penalties for users who consistently receive ratings below a predetermined threshold (e.g., below 3 (out of 5) over the past 1 month or for the most recent 5 reviews), with actions such as temporary suspension (e.g., suspension of the user account) or additional verification procedures (e.g., requires the user to upload particular documentation) for low-rated users. The recovery manager 184 can give users with a rating of less than 3 stars an opportunity to undergo corrective actions or skills training offered through the platform to improve their future ratings. The recovery manager 184 can automatically determine, based on their ratings and corresponding review questions, an areas where the low-rated users (e.g., users with a rating of less than 3 stars) can improve. For example, in response to determining that a particular user has been consistently given “no” to the question “was the day laborer punctual and reliable in showing up to work and completing tasks on time?”, the recovery manager 184 can automatically determine “punctuality” to be the area where the particular can improve, and provide, to the particular user, online training courses or sessions relating to punctuality. The recovery manager 184 can provide a performance dashboard (e.g., a user interface showing a performance of a particular user) that allows users to track their historical ratings, review feedback trends, and view areas where they can improve to boost their ratings. The recovery manager 184 can perform a rating reset feature that allows users to appeal low ratings under specific conditions and have their rating reset after a set period of improved performance. For example, in response to determining that a particular user has received a rating above a threshold consistently, e.g., for a predetermined duration or a predetermined number of recent reviews, the recovery manager 184 can reset a rating of a particular user (e.g., reset to the default 5-star rating or a rating before receiving low ratings). In this manner, the recovery manager 184 can provide opportunities for users with low ratings to recover by improving their performance over time.

In some implementations, the rating system can allow employers and day laborers to view each other's ratings before offering a job or accepting job offers, ensuring transparency in the hiring process. The rating system can incentivize good behavior and accountability, as users know their rating can affect their future job prospects.

In some implementations, a method for dynamically adjusting the 5-star ratings of users in an employment platform, may include assigning a default 5-star rating to an employer or day laborer upon account creation (e.g., in response to the account of the employer or day laborer being created in the rating system). The method may include collecting star ratings and detailed reviews (e.g., performance feedback) from users (e.g., the employer or day laborer) after completion of each job. The method may include recalculating the overall rating of the employer or day laborer based on the average of recent reviews. The method may include adjusting the user's rating, allowing the rating to increase back to 5, decrease, or remain constant based on performance feedback. The method may include sending the user a notification (e.g., message) of any rating changes and providing a summary of the feedback associated with the change. The method may include using algorithms to weigh more recent ratings more heavily in the overall rating calculation, ensuring the rating accurately reflects current performance.

In some implementations, review questions for job seekers or day laborers may indicate what makes a person (e.g., job seeker or day laborer) want to work for an employer. For example, top 5 review questions for day laborers may relate to (1) fair compensation (fair pay and clear communication about compensation foster trust and make workers feel valued), (2) professionalism and respect (being treated with respect creates a positive and safe working environment, encouraging future work), (3) clear instructions and expectations (clear communication helps laborers feel confident in completing their tasks successfully, reducing frustration), (4) timeliness in payment (timely payment is essential for building trust and ensuring that laborers are willing to work with the employer again), and (5) support and responsiveness (being available and responsive when issues arise shows that the employer values the worker's time and effort). The top 5 review questions may include (1) fair compensation-“Was the employer transparent and fair in the pay offered for the work completed?”; (2) professionalism and respect—“Did the employer treat you with professionalism and respect throughout the job?”; (3) clear instructions and expectations—“Did the employer provide clear instructions and set realistic expectations for the job?”; (4) timeliness in payment—“Did the employer pay you on time and as agreed?”; and (5) support and responsiveness—“Was the employer responsive and supportive when you needed assistance or clarification?”.

In some implementations, review questions for employers may indicate what workers (e.g., day laborers) need to succeed on the job. For example, top 5 review questions for employers may relate to (1) punctuality and reliability (being punctual and reliable is crucial to establishing trust and ensuring the job runs smoothly), (2) work ethic and productivity (consistent productivity and dedication to doing quality work are key traits for long-term success in the workplace), (3) attitude and adaptability (a positive attitude and flexibility are critical for handling dynamic job requirements and building strong work relationships), (4) communication and understanding (open communication prevents misunderstandings and ensures that tasks are completed correctly and efficiently), and (5) skill proficiency and knowledge (having the required skillset ensures that the worker can perform their job well and contribute to the employer's success). The top 5 review questions may include (1) punctuality and reliability—“Was the day laborer punctual and reliable in showing up to work and completing tasks on time?”; (2) work ethic and productivity—“Did the day laborer demonstrate a strong work ethic and complete tasks efficiently and accurately?”; (3) attitude and adaptability—“Did the day laborer maintain a positive attitude and adapt to changing requirements or challenges?”; (4) communication and understanding—“Did the day laborer communicate effectively and ask for clarification when needed?”; and (5) skill proficiency and knowledge—“Did the day laborer demonstrate the necessary skills and knowledge to complete the assigned tasks?”. These review questions target important aspects of the worker-employer relationship, ensuring that both sides have clear expectations, mutual respect, and the tools they need to succeed.

In some implementations of the present disclosure, a system for controlling notifications relating to rating information, may include one or more processors and memory. The one or more processors may be configured to receive a first value input by a first user at a first time point, and determine a first rating of performance of a third user using the first value and the first time point. The one or more processors may be configured to receive a second value input by a second user at a second time point later than the first time point, and determine a second rating of the performance of the third user using the first value, the first time point, the second value and the second time point. The one or more processors may be configured to determine a difference between the first rating and the second rating, and send a first notification to at least one of the first user, the second user or the third user.

In some implementations, in determining the second rating, the one or more processors may be configured to calculate a plurality of weights corresponding to a plurality of values using a plurality of time points respectively associated with the plurality of values. The plurality of values may be input by one or more users and include the first value and the second value, and the weight corresponding to the second value may be greater than the weight corresponding to the first value. The one or more processors may be configured to calculate a weighted average of the plurality of values using the plurality of weights.

In some implementations, a weight corresponding to a value associated with a time point later than another time point may be greater than a weight corresponding to a value associated with the other time point. In some implementations, the plurality of weights may have one of a linear weighting scale or an exponential weighting scale.

In some implementations, in determining the second rating, the one or more processors may be configured to determine a plurality of ratings including the first rating and the second rating. The one or more processors may be configured to determine that a number of consecutive ratings, each of which is less than a first threshold, is greater than a second threshold, and send a second notification to at least one of the first user, the second user or the third user.

In some implementations, in determining the second rating, the one or more processors may be configured to determine a plurality of ratings including the first rating and the second rating. The one or more processors may be configured to determine that a number of consecutive ratings, each of which is greater than a third threshold, is greater than a fourth threshold, and send a third notification to at least one of the first user, the second user or the third user.

In some implementations, the first user and the second user may be employers. The third user may be a person employed by at least one of the first user or the second user. In some implementations, the first user and the second user may be persons. The third user may be an employer of at least one of the first user or the second user.

In some implementations, the system may include a display configured to display a plurality of questions. For each question, the display may display options that can be input as an answer to a respective one of the plurality of questions, the options including a first option and a second option. In response to the plurality of questions being displayed, the one or more processors may be configured to receive a number of the first options input by the first user at the first time as answers to the plurality of questions. The one or more processors may be configured to determine the number of the first options as the first value. In response to the plurality of questions being displayed, the one or more processors may be configured to receive a number of the first options input by the second user at the second time as answers to the plurality of questions. The one or more processors may be configured to determine the number of the first options as the second value.

Various implementations in the present disclosure have one or more of the following advantages and benefits.

First, implementations in the present disclosure can assign a default 5-star rating to both employers and day laborers when they register on the application employment platform. In some implementations, as jobs are completed, both parties can rate each other using a rating system. The rating system can adjust their overall rating dynamically such that ratings can increase back to 5, decrease, or remain stable depending on feedback received. The system can incorporate penalties for low ratings and recovery mechanisms for users seeking to improve their standing.

Second, implementations in the present disclosure can weight recent reviews more heavily to provide a dynamic reflection of a user's current performance. In some implementations, a rating system can reflect recent performance of an employer or a day laborer by giving more importance to recent ratings, which means current performance is emphasized.

The rating system can provide ratings of users dynamically and adaptively. The rating system can use an algorithm that adjusts the ratings automatically based on the number of ratings, ensuring that it scales with the worker's or employer's history. By using this algorithm, the rating system can ensure that the overall rating remains relevant and reflects the most up-to-date interactions, providing a fair and dynamic rating system.

Second, implementations in the present disclosure can balance history and current performance. In some implementations, a rating system can still consider older ratings but give the older ratings less weight, maintaining a balanced view of long-term performance.

FIG. 2 is a block diagram illustrating an example of a computing system according to some implementations.

Referring to FIG. 2, the illustrated example computing system 172 includes one or more processors 210 in communication, via a communication system 240 (e.g., bus), with memory 260, at least one network interface controller 230 with network interface port for connection to a network (not shown), and other components, e.g., an input/output (“I/O”) components interface 450 connecting to a display (not illustrated) and an input device (not illustrated). Generally, the processor(s) 210 will execute instructions (or computer programs) received from memory. The processor(s) 210 illustrated incorporate, or are directly connected to, cache memory 220. In some instances, instructions are read from memory 260 into the cache memory 220 and executed by the processor(s) 210 from the cache memory 220.

In more detail, the processor(s) 210 may be any logic circuitry that processes instructions, e.g., instructions fetched from the memory 260 or cache 220. In some implementations, the processor(s) 210 are microprocessor units or special purpose processors. The computing device 200 may be based on any processor, or set of processors, capable of operating as described herein. The processor(s) 210 may be single core or multi-core processor(s). The processor(s) 210 may be multiple distinct processors.

The memory 260 may be any device suitable for storing computer readable data. The memory 260 may be a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or Blu-Ray®discs). A computing system 172 may have any number of memory devices as the memory 260.

The cache memory 220 is generally a form of computer memory placed in close proximity to the processor(s) 210 for fast read times. In some implementations, the cache memory 220 is part of, or on the same chip as, the processor(s) 210. In some implementations, there are multiple levels of cache 220, e.g., L2 and L3 cache layers.

The network interface controller 230 manages data exchanges via the network interface (sometimes referred to as network interface ports). The network interface controller 230 handles the physical and data link layers of the OSI model for network communication. In some implementations, some of the network interface controller's tasks are handled by one or more of the processor(s) 210. In some implementations, the network interface controller 230 is part of a processor 210. In some implementations, a computing system 172 has multiple network interfaces controlled by a single controller 230. In some implementations, a computing system 172 has multiple network interface controllers 230. In some implementations, each network interface is a connection point for a physical network link (e.g., a cat-5 Ethernet link). In some implementations, the network interface controller 230 supports wireless network connections and an interface port is a wireless (e.g., radio) receiver/transmitter (e.g., for any of the IEEE 802.11 protocols, near field communication “NFC”, Bluetooth, ANT, or any other wireless protocol). In some implementations, the network interface controller 230 implements one or more network protocols such as Ethernet. Generally, a computing device 172 exchanges data with other computing devices via physical or wireless links through a network interface. The network interface may link directly to another device or to another device via an intermediary device, e.g., a network device such as a hub, a bridge, a switch, or a router, connecting the computing device 172 to a data network such as the Internet.

The computing system 172 may include, or provide interfaces for, one or more input or output (“I/O”) devices 250. Input devices include, without limitation, keyboards, microphones, touch screens, foot pedals, sensors, MIDI devices, and pointing devices such as a mouse or trackball. Output devices include, without limitation, video displays, speakers, refreshable Braille terminal, lights, MIDI devices, and 2-D or 3-D printers.

Other components may include an I/O interface, external serial device ports, and any additional co-processors. For example, a computing system 172 may include an interface (e.g., a universal serial bus (USB) interface) for connecting input devices, output devices, or additional memory devices (e.g., portable flash drive or external media drive). In some implementations, a computing device 172 includes an additional device such as a co-processor, e.g., a math co-processor can assist the processor 210 with high precision or complex calculations.

FIG. 3 to FIG. 8 are example user interfaces 300, 400, 500, 600, 700, 800 for displaying and receiving rating information on a user device (e.g., a user device of an employer) according to some implementations. An employment platform (e.g., job matching platform) can use a rating control system to facilitate employment onboarding for job seekers (e.g., day laborers). The platform can enable users to electronically complete necessary employment forms (I-9, W-4), upload supporting documentation, and create a video (e.g., a 30-second introductory video). These documents and data can be transmitted to employers when the day laborer is hired for a shift. The platform can simplify the hiring process for both laborers and employers.

FIG. 3 is an example user interface 300 for logging into an employment platform according to some implementations. The user interface 300 can show a home page or a landing page of the employment platform (e.g., a rating system). In response to clicking a home button 310, a rating system (e.g., the user interface manager 140) can display the user interface 300. The user interface 300 can include a sign-in button 320, a sign-in button 330, a sign-in button 340 and/or a sign-in button 350 for an existing employer (who already has an account in the system), a new employer, an existing day laborer (who already has an account in the system), and/or a new day laborer, respectively. The rating system can show the user interfaces 400, 500, 600, 700, 800, when an employer logs into the system (e.g., by clicking the button 320 in FIG. 3).

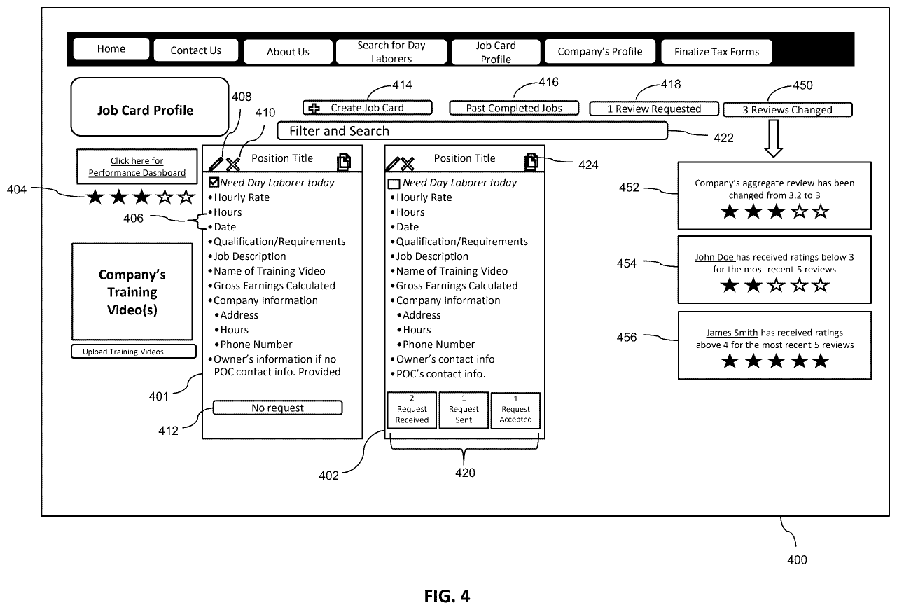

FIG. 4 is an example user interface 400 for creating a job card (e.g., job card profile, job announcement, job post, recruiting card, recruiting announcement, recruiting post) by an employer, according to some implementations. The user interface 400 can include a job card 401, a job card 402, a review or a rating 404 (e.g., 5-star rating), a date/time 406, an edit button 408, a delete button 410, a job card status 412, a create job card button 414, a past completed jobs button 416, a number of reviews requested 418, a job card status 420, a search input 422, a copy button 424, a number of reviews changed button 450, a rating (review) change notification 452, a rating (review) change notification 454, and/or a rating (review) change notification 456.

Referring to FIG. 4, when an employer (e.g., company) has signed in the system, the user interface 400 can display a job card profile of the employer including information on one or more job cards posted by the employer (e.g., the job cards 401, 402). The rating 404 indicates an aggregate of all reviews (ratings) day laborers have given the employer. When the employer clicks the create job card button 414, the user interface 400 can allow the employer to select multiple dates and time slots (e.g., dates/hours 406) for a new job card (e.g., new job post). In response to selecting dates and time slots, the system can create a new job card for each new time slot or date selected. For each job card, the edit button 408 can allow the employer to edit the job card until a request (e.g., request for job application or job offer) has been received (e.g., from one or more day laborers) or sent (e.g., to one or more day laborers). After a request is sent or received the job card can be locked. The delete button 410 can allow the employer to delete the job card only until a job has been secured and/or a day laborer has been hired. The job card status 412 can indicate “No request” as a default text until at least one request is sent by an employer or received by a day laborer. Once the create job card button 414 is clicked, a new job card can pop-up and only fields that are classified as 1 can be edited. The past completed jobs button 416 can allow the employer to view past completed jobs (as a default filter view). The number of reviews requested 418, once clicked, can take the employer to a page of the reviews requested, on which the employer can leave a review of all day laborers who have completed work. The job card status 420 can include boxes indicating the number of requests received, the number of request sent, and/or the number of request accepted. These boxes can only show after at least one request has been received or sent. By clicking on any of these boxes, the employer can see one or more requests received from day laborers, one or more requests the employer has sent, and one or more day laborers who secured the job. The search input 422 can filter all fields in the job card. The copy button 424 can allow the employer to duplicate a job card and only change date and/or hours.

The number of reviews changed button 450 can allow the employer to see notifications (e.g., messages) relating to review changes. When the employer clicks the number of reviews changed button 450, the user interface 400 can display (1) the rating (review) change notification 452 that the employer's aggregate review has been changed from 3.2 to 3; (2) the rating (review) change notification 454 that the day laborer John Doe has received ratings below 3 for recent 5 reviews; and/or (3) the rating (review) change notification 456 that the day laborer James Smith has received ratings above 4 for recent 5 reviews.

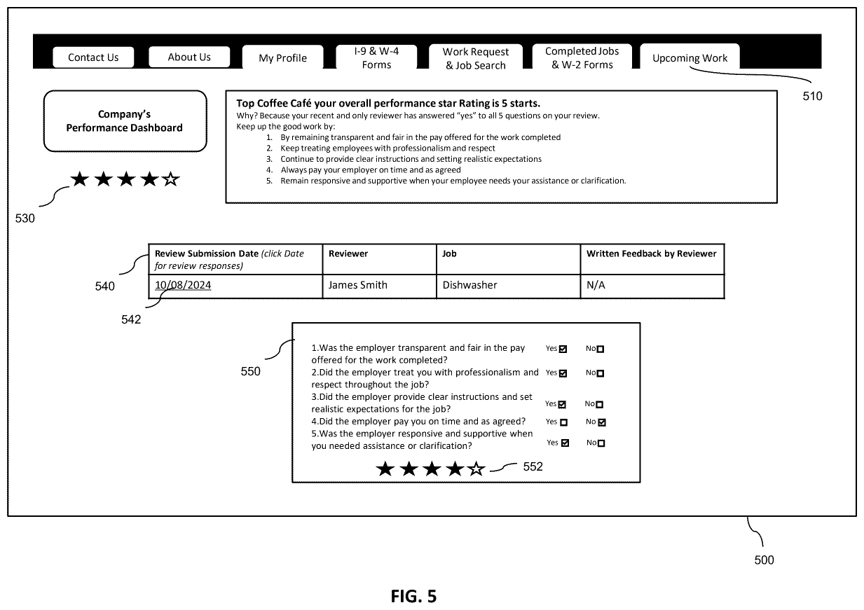

FIG. 5 is an example user interface 500 (e.g., performance dashboard) for displaying performance of an employer (e.g., a company) based on reviews of the employer by day laborers, according to some implementations. The user interface 500 can include an upcoming work button 510, a rating 530 (e.g., 5-star rating), a review history 540, a review submission date 542, a historical detailed review 550 and/or a historical rating 552. The upcoming work button 510 can blink (e.g., blink red) when work is scheduled within a predetermined time (e.g., within the hour). The rating 530 can indicate the employer's aggregate review (aggregate rating) given by day laborers. The user interface 500 can show the review history 540 of the employer given by day laborers. Once the employer clicks the review submission date 540, the historical detailed review 550 can pop up to show details of the review and the rating 552.

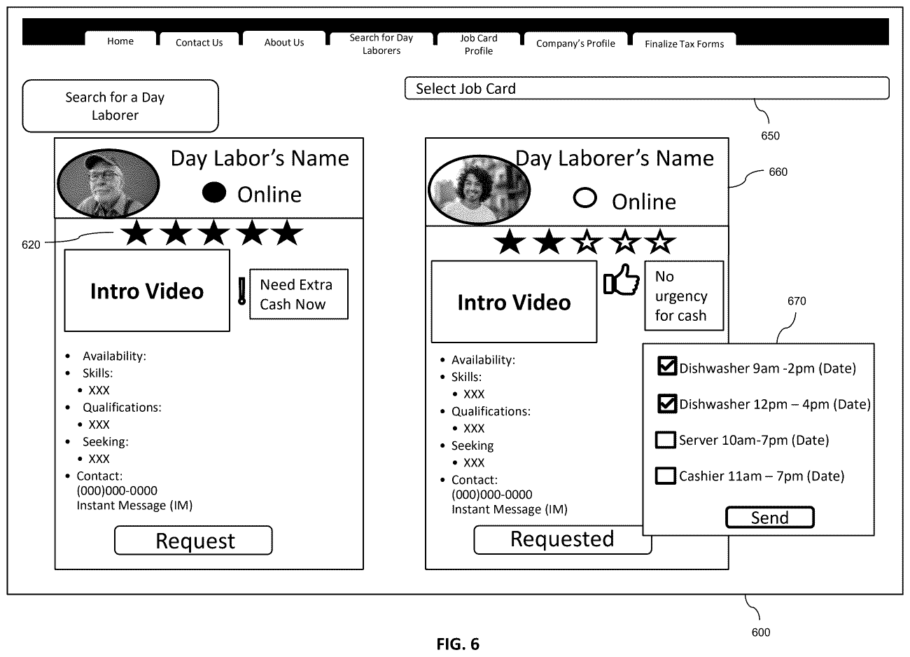

FIG. 6 is an example user interface 600 for searching for a day laborer, according to some implementations. The user interface 600 can include a rating 620 (e.g., 5-star rating), a job card selection input 650, a day laborer profile 660, and/or a job positions box 670. In some implementations, there can be two ways to perform a search for day laborers: selective search and open search. The job card selection input 650 can allow an employer to perform a selective search. After the employer has created job card(s), the employer can use the job card selection input 650 to select a job card they would like to search for available day laborers. The user interface 600 can align the availability of a day laborer 660 and the date and hours on the job card, and then allow the employer to select the day laborer 660 (e.g., by clicking the “request” button). The job positions box 670 can only pop-up after the employer has selected “request”. Only job cards that align with the day laborer's availability can be shown in the box 670. After the employer selects at least one position from the box 670, the employer can click the “send” button, and then the day laborer can receive a notification of the request. The status of the day laborer profile 660 can then change to “requested”.

In some implementations, instead of performing the selective search, the user interface manager 140 can perform an open search for day laborers by displaying buttons for exact match, adaptive experience, functional similarity match, and/or dreamer match (not shown). The rating 620 can indicate an aggregate of all reviews the (searched) day laborer has received from employers (e.g., companies). In some implementations, day laborers can remain with no stars until at least one review is made.

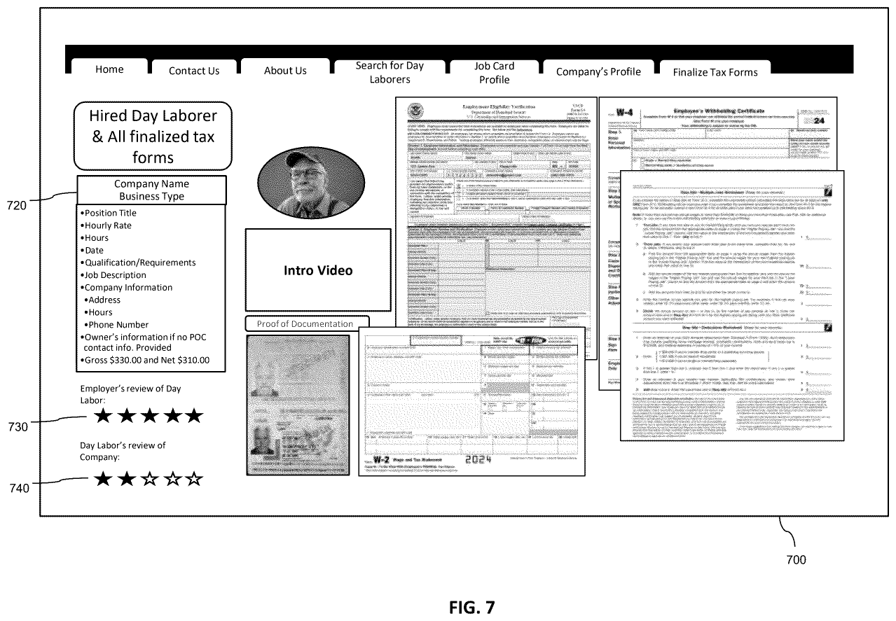

FIG. 7 is an example user interface 700 for displaying information of a hired day laborer, according to some implementations. The user interface 700 can include completed job information 720, a rating of the hired day laborer 730 (e.g., 5-star rating), and/or a rating of the employer 740. The user interface 700 can display information of the hired day laborer and his or her all finalized tax forms. The completed job information 720 can indicate all jobs the day laborer has completed with this employer. The rating of the hired day laborer 730 can indicate the employer's review of the day labor which is an aggregate of all reviews the employer has given to the day laborer. The review (or rating) of the employer can indicate an aggregate of all reviews the day laborer has given to the employer.

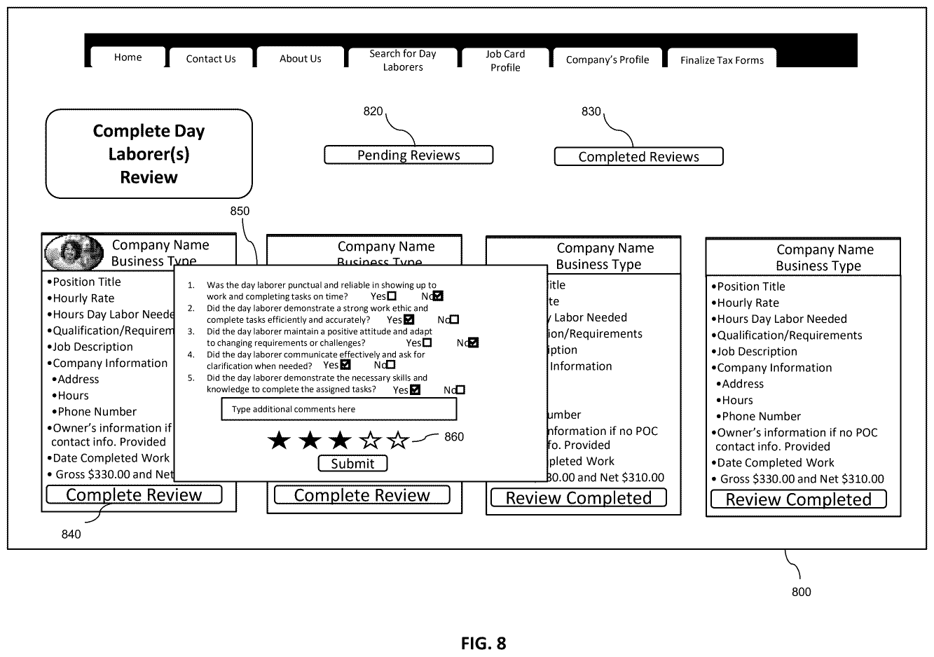

FIG. 8 is an example user interface 800 for writing and submitting a review of a day laborer, according to some implementations. The user interface 800 can include a review complete button 840, a pop-up review box 850, a review or rating of the day laborer 852 (e.g., 5-star rating), a pending reviews button 820, and/or a completed reviews button 830. The pending reviews button 820 can allow the employer to display pending reviews as a default filter view. The completed reviews button 830 can allow the employer to display completed reviews as a default filter view. Clicking the review complete button 840 can bring the pop-up review box 850 with questions for the employer to answer and submit feedback. In the pop-up review box 850, the user interface 800 can display a colored star for each “Yes” input by the employer, and does not display a colored star for each “No” input by the employer.

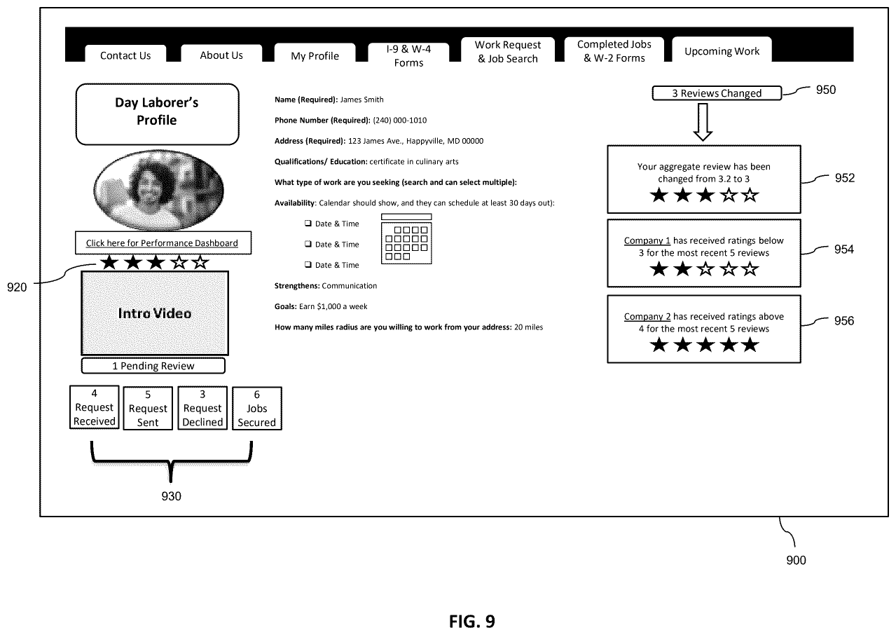

FIG. 9 to FIG. 14 are example user interfaces 900, 1000, 1100, 1200, 1300, 1400 for displaying and receiving rating information on a user device (e.g., a user device of a day laborer) according to some implementations. The rating system can show the user interfaces 900, 1000, 1100, 1200, 1300, 1400, when a day laborer logs into the system (e.g., by clicking the button 340 in FIG. 3).

FIG. 9 is an example user interface 900 for displaying information of a day laborer, according to some implementations. The user interface 900 can include a review or rating of the day laborer 920 (e.g., 5-star rating), status boxes 930, a number of reviews changed 950, a rating (review) change notification 952, a rating (review) change notification 954, and/or a rating (review) change notification 956.

Referring to FIG. 9, when a day laborer has signed in the system, the user interface 900 can display information of the day laborer (e.g., day laborer's profile). The rating of the day laborer 920 can indicate an aggregate of all reviews the day laborer has received from all employers (e.g., companies). The status boxes 930 can include a number of requests received by the day laborer, a number of requests sent by the day laborer, a number of requests declined by employers, and/or a number of jobs secured by the day laborer. The numbers shown in the status boxes can be aggregates for the calendar year. The number of reviews changed button 950 can allow the day laborer to see notifications (e.g., messages) relating to review changes. When the day laborer clicks the number of reviews changed button 950, the user interface 900 can display (1) the rating (review) change notification 952 that the day laborer's aggregate review has been changed from 3.2 to 3; (2) the rating (review) change notification 954 that the employer Company 1 has received ratings below 3 for recent 5 reviews; and/or (3) the rating (review) change notification 956 that the employer Company 2 has received ratings above 4 for recent 5 reviews.

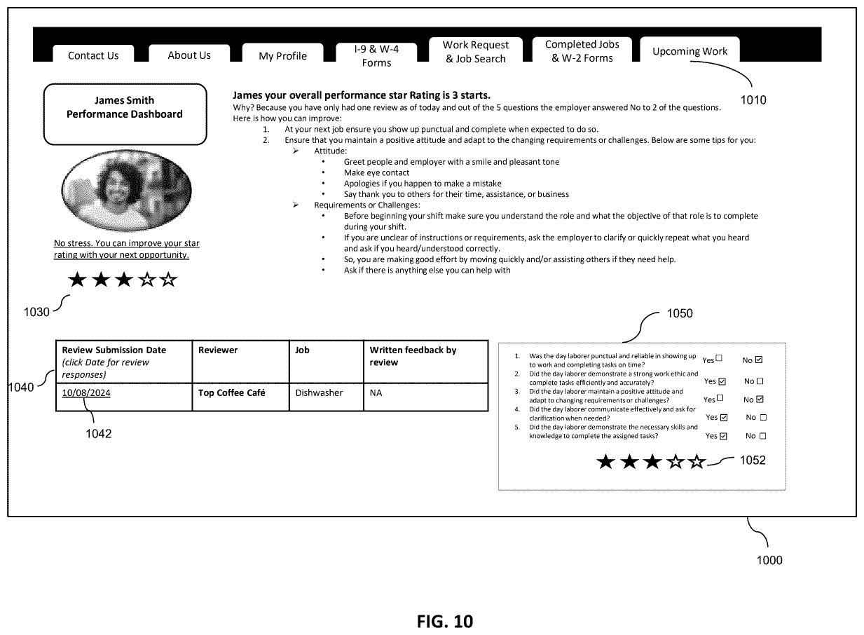

FIG. 10 is an example user interface 1000 (e.g., performance dashboard) for displaying performance of a day laborer based on reviews of the day laborer by employers, according to some implementations. The user interface 1000 can include an upcoming work button 1010, a rating 1030 (e.g., 5-star rating), a review history 1040, a review submission date 1042, a historical detailed review 1050 and/or a historical rating 1052. The upcoming work button 1010 can blink (e.g., blink red) when work is scheduled within a predetermined time (e.g., within the hour). The rating 1030 can indicate the day laborer's aggregate review (aggregate rating) given by employers. The user interface 1000 can show the review history 1040 of the day laborer given by employers. Once the day laborer clicks the review submission date 1040, the historical detailed review 1050 can pop up to show details of the review and the rating 1052.

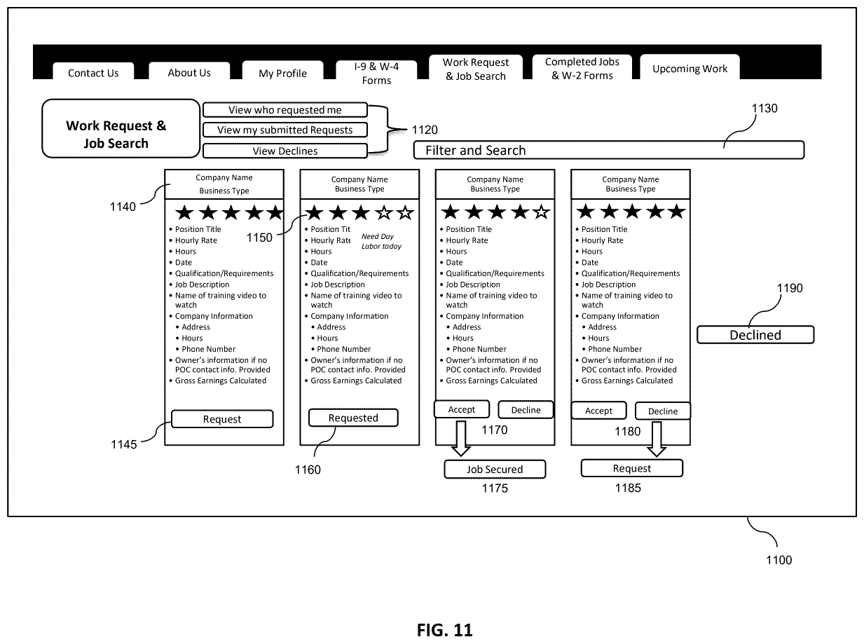

FIG. 11 is an example user interface 1100 for searching for a job, according to some implementations. The user interface 1100 can include view buttons 1120, a filter and search input 1130, a job card profile 1140, a request button 1145, a review or rating of an employer 1150 (e.g., 5-star rating), a request status 1160, an accept/decline button 1170, job offer status 1175, an accept/decline button 1180, job offer status 1185, and/or a job offer status 1190.

Referring to FIG. 11, the user interface 1100 can allow the day laborer to request a work and/or search for a job. The view buttons 1120 can allow the day laborer to view who requested the day laborer, view the requests submitted by the day laborer, and/or view declines received by the day laborer. The filter and search input 1130 can filter all fields in the job card. For example, from the “address” field, the day laborer can filter by mile radius from employers' address or zip code and overlap their availability. In addition to seeing where they are, the user interface manager 140 can allow the day laborer to perform an open search by providing buttons for exact match, adaptive experience, functional similarity match, and/or dreamer match (not shown). The job card profile 1140 can be a link such that once the day laborer clicks on the link, the user interface 1100 can open a job card profile of an employer (e.g., company) where the day laborer can see all available job cards for that company. The request button 1145 can allow the day laborer to request a job and change this button to “requested” status (e.g., the “requested” status as shown in the request status 1160). The rating of the employer 1150 can indicate an aggregate of all reviews day laborers have given the employer. The request status 1160 can allow the day laborer to double click the request status 1160 to cancel the request and put the request status back in “request” status. The accept/decline button 1170, 1180 can be only display if an employer has requested that day laborer. Once the day laborer has accepted the request, the status can change to “job secured” as shown in the job offer status 1175 and then the day laborer can be prompt to give access to profile, I-9 and W-4 form within an hour of shift starting. Once the day laborer has declined the request, the status can revert to “request” as shown in the job offer status 1185. The “Declined” status (in the job offer status 1190) can be only shown for the day laborer if the position has been filled by another day laborer.

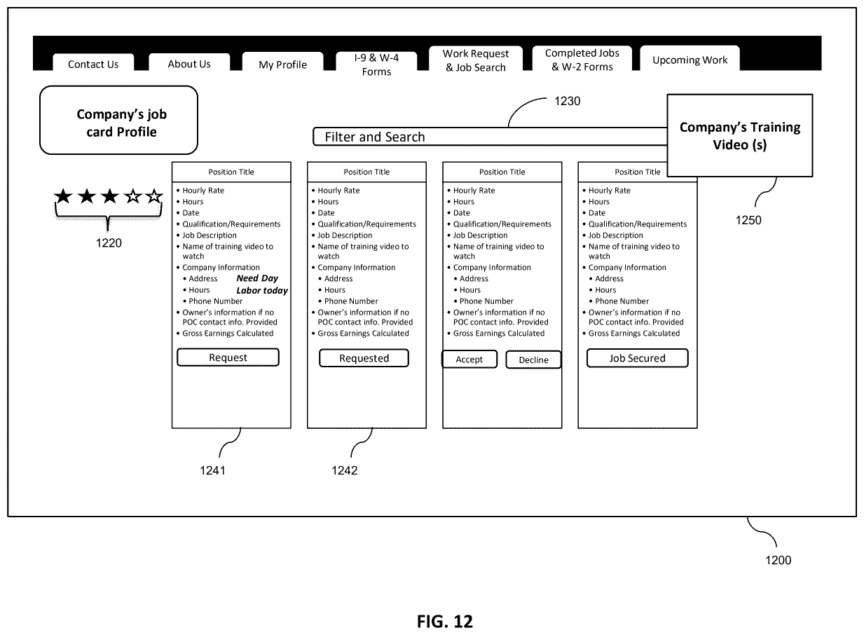

FIG. 12 is an example user interface 1200 for displaying information of an employer (e.g., company profile) and one or more jobs posted by the employer (e.g., job card profile), according to some implementations. The user interface 1200 can include a review or rating of an employer 1220 (e.g., 5-star rating) and/or a filter and search input 1230. The user interface 1200 can allow a day laborer to access a job card profile of an employer including one or more job cards 1241, 1242, for example. The rating of the employer 1220 can indicate an aggregate of all reviews left by day laborers. The filter and search input 1230 can allow the day laborer to filter fields of a job card and search for a job. In the user interface 1200, day labors can only view all jobs the employer has posted, watch the employer's training videos 1150, and submit, accept, or decline request.

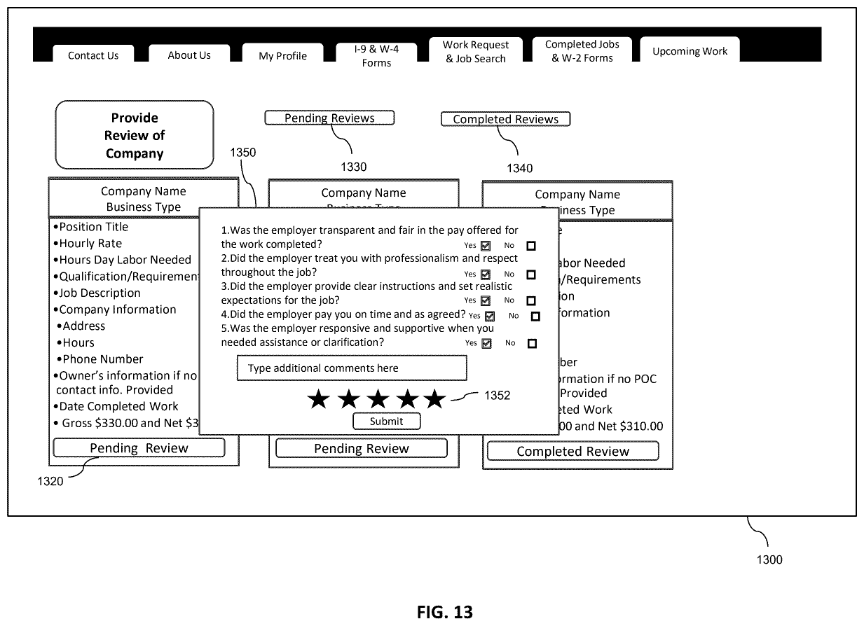

FIG. 13 is an example user interface 1300 for writing and submitting a review of an employer, according to some implementations. The user interface 1300 can include a pending review button 1320, a pop-up review box 1350, a review or rating of the day laborer 1352 (e.g., 5-star rating), a pending reviews button 1330, and/or a completed reviews button 1340. The pending reviews button 1330 can allow a day laborer to display pending reviews as a default filter view. The completed reviews button 1340 can allow the day laborer to display completed reviews as a default filter view. Clicking the pending review button 1320 can bring the pop-up review box 1350 with questions for the day laborer to answer and submit feedback. In the pop-up review box 1350, the user interface 1300 can display a colored star for each “Yes” input by the day laborer, and does not display a colored star for each “No” input by the day laborer.

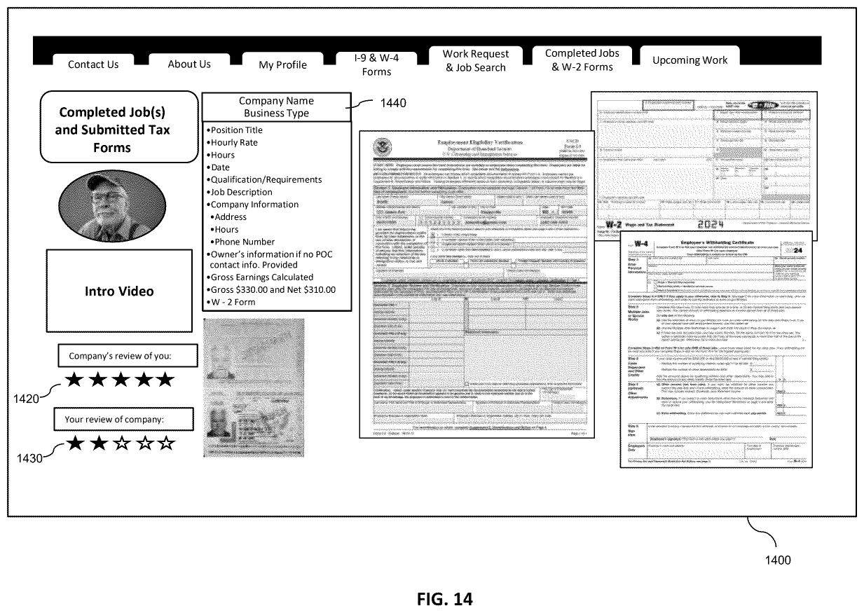

FIG. 14 is an example user interface 1400 for displaying one or more jobs completed by a day laborer and documentation on the day laborer, according to some implementations. The user interface 1400 can include one or more jobs (of an employer) 1440, a rating of the day laborer 1420 (e.g., 5-star rating), and/or a rating of the employers 1430. The user interface 1400 can display one or more jobs 1440 completed by the day laborer and his or her all finalized tax forms. The completed job information 1440 can indicate all jobs the day laborer has completed with this employer. The rating of the day laborer 1420 can indicate an aggregate of all reviews the employer has given to the day laborer. The review (or rating) of the employer 1430 can indicate an aggregate of all reviews the day laborer has given to the employer. If the day laborer completes multiple jobs for the same employer, the user interface 1400 can show all completed job cards.

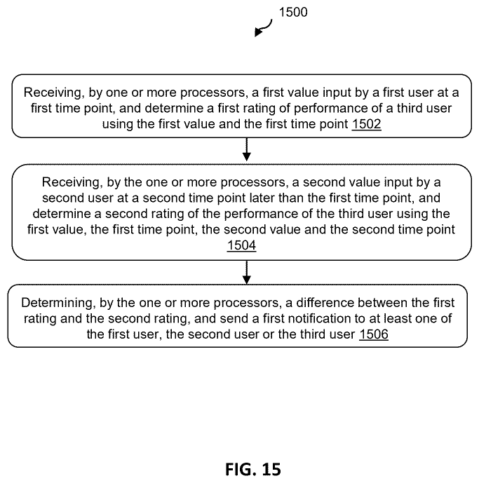

FIG. 15 is a flowchart illustrating an example methodology for controlling notifications relating to rating information according to some implementations.

In this example methodology, the process 1500 begins at step 1502 by receiving, by one or more processors (e.g., one or more processors 210 of rating control system 100), a first value input by a first user at a first time point (e.g., rating R4 input by an employer at a time corresponding to weight W4), and determining a first rating of performance of a third user (e.g., a day laborer) using the first value and the first time point (e.g., using Formula 1). In some implementations, the system may include a display configured to display a plurality of questions (e.g., 5 questions in a review box 850). For each question, the display may display options that can be input as an answer to a respective one of the plurality of questions, the options including a first option (e.g., “Yes” in the review box 850) and a second option (e.g., “No” in the review box 850). In response to the plurality of questions being displayed, the one or more processors may be configured to receive a number of the first options input by the first user at the first time (e.g., 4 “Yes” input by the employer in the review box 850) as answers to the plurality of questions. The one or more processors may be configured to determine the number of the first options as the first value (e.g., determine 4 as the rating of the day laborer).

At step 1504, in some implementations, the one or more processors may be configured to receive a second value input by a second user at a second time point later than the first time point (e.g., rating R5 input by the employer at a time corresponding to weight W5), and determine a second rating of the performance of the third user (e.g., the day laborer) using the first value, the first time point, the second value and the second time point (e.g., using Formula 1). In response to the plurality of questions being displayed, the one or more processors may be configured to receive a number of the first options input by the second user at the second time as answers to the plurality of questions. The one or more processors may be configured to determine the number of the first options as the second value.

In some implementations, in determining the second rating, the one or more processors may be configured to calculate a plurality of weights (e.g., W1, W2, W3, W4, W5) corresponding to a plurality of values (e.g., R1, R2, R3, R4, R5) using a plurality of time points respectively associated with the plurality of values. The plurality of values may be input by one or more users and include the first value (e.g., R4) and the second value (R5), and the weight corresponding to the second value (W5) may be greater than the weight corresponding to the first value (W4). The one or more processors may be configured to calculate a weighted average of the plurality of values using the plurality of weights (e.g., using Formula 1).

In some implementations, a weight corresponding to a value associated with a time point later than another time point may be greater than a weight corresponding to a value associated with the other time point. For example, the rating manager 160 (e.g., weighting manager 166) may give more recent reviews a higher influence (or weight) on the overall rating than older reviews, ensuring a dynamic reflection of performance of an employer or a day laborer. In some implementations, the plurality of weights may have one of a linear weighting scale or an exponential weighting scale.

In some implementations, the first user and the second user may be employers. The third user may be a person (e.g., day laborer) employed by at least one of the first user or the second user. In some implementations, the first user and the second user may be persons. The third user may be an employer of at least one of the first user or the second user.

At step 1506, in some implementations, the one or more processors may be configured to determine a difference between the first rating and the second rating, and send a first notification (e.g., notification 952 that a day laborer's aggregate review has been changed from 3.2 to 3) to at least one of the first user, the second user or the third user.

In some implementations, in determining the second rating, the one or more processors may be configured to determine a plurality of ratings including the first rating and the second rating. The one or more processors may be configured to determine that a number of consecutive ratings, each of which is less than a first threshold, is greater than a second threshold (e.g., the ratings of a particular user is below 3 (out of 5) over the past 1 month or for the most recent 5 reviews), and send a second notification (e.g., notification 454) to at least one of the first user, the second user or the third user.

In some implementations, in determining the second rating, the one or more processors may be configured to determine a plurality of ratings including the first rating and the second rating. The one or more processors may be configured to determine that a number of consecutive ratings, each of which is greater than a third threshold, is greater than a fourth threshold (e.g., the ratings of a particular user is above 4 (out of 5) over the past 1 month or for the most recent 5 reviews), and send a third notification (e.g., notification 455) to at least one of the first user, the second user or the third user.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of blocks in the processes disclosed is an example of illustrative approaches. Based upon design preferences, it is understood that the specific order or hierarchy of blocks in the processes may be rearranged while remaining within the scope of the previous description. The accompanying method claims present elements of the various blocks in a sample order, and are not meant to be limited to the specific order or hierarchy presented.

The previous description of the disclosed implementations is provided to enable any person skilled in the art to make or use the disclosed subject matter. Various modifications to these implementations will be readily apparent to those skilled in the art, and the generic principles defined herein may be applied to other implementations without departing from the spirit or scope of the previous description. Thus, the previous description is not intended to be limited to the implementations shown herein but is to be accorded the widest scope consistent with the principles and novel features disclosed herein.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the blocks of various examples must be performed in the order presented. As will be appreciated by one of skill in the art the order of blocks in the foregoing examples may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the examples disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In some examples, the functions described may be implemented in hardware, software, firmware, or any combination thereof. If implemented in software, the functions may be stored as one or more instructions or code on a non-transitory computer-readable storage medium or non-transitory processor-readable storage medium. The blocks of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present disclosure. Various modifications to these examples will be readily apparent to those skilled in the art, and the generic principles defined herein may be applied to some examples without departing from the spirit or scope of the disclosure. Thus, the present disclosure is not intended to be limited to the examples shown herein but is to be accorded the widest scope consistent with the following claims and the principles and novel features disclosed herein.

What is claimed is:

1. A system for controlling notifications relating to rating information, comprising:
one or more processors and memory,
wherein the one or more processors are configured to;
receive a first value input by a first user at a first time point, and determine a first rating of performance of a third user using the first value and the first time point;
receive a second value input by a second user at a second time point later than the first time point, and determine a second rating of the performance of the third user using the first value, the first time point, the second value and the second time point; and
determine a difference between the first rating and the second rating, and send a first notification to at least one of the first user, the second user or the third user.

2. The system according to claim 1, wherein in determining the second rating, the one or more processors are configured to:
calculate a plurality of weights corresponding to a plurality of values using a plurality of time points respectively associated with the plurality of values, wherein the plurality of values are input by one or more users and include the first value and the second value, and the weight corresponding to the second value is greater than the weight corresponding to the first value; and
calculate a weighted average of the plurality of values using the plurality of weights.

3. The system according to claim 2, wherein a weight corresponding to a value associated with a time point later than another time point is greater than a weight corresponding to a value associated with the other time point.

4. The system according to claim 2, wherein the plurality of weights has one of a linear weighting scale or an exponential weighting scale.

5. The system according to claim 1, wherein in determining the second rating, the one or more processors are configured to:
determine a plurality of ratings including the first rating and the second rating; and
determine that a number of consecutive ratings, each of which is less than a first threshold, is greater than a second threshold, and send a second notification to at least one of the first user, the second user or the third user.

6. The system according to claim 1, wherein in determining the second rating, the one or more processors are configured to:
determine a plurality of ratings including the first rating and the second rating; and
determine that a number of consecutive ratings, each of which is greater than a third threshold, is greater than a fourth threshold, and send a third notification to at least one of the first user, the second user or the third user.

7. The system according to claim 1, wherein
the first user and the second user are employers, and
the third user is a person employed by at least one of the first user or the second user.

8. The system according to claim 1, wherein
the first user and the second user are persons, and
the third user is an employer of at least one of the first user or the second user.

9. The system according to claim 1, further comprising:
a display configured to
display a plurality of questions; and
for each question, display options that can be input as an answer to a respective one of the plurality of questions, the options including a first option and a second option, wherein the one or more processors are configured to:
in response to the plurality of questions being displayed, receive a number of the first options input by the first user at the first time as answers to the plurality of questions, and
determine the number of the first options as the first value.

10. The system according to claim 9, wherein
the one or more processors are configured to:
in response to the plurality of questions being displayed, receive a number of the first options input by the second user at the second time as answers to the plurality of questions, and
determine the number of the first options as the second value.

11. A method for controlling notifications relating to rating information, comprising:
receiving, by one or more processors, a first value input by a first user at a first time point, and determine a first rating of performance of a third user using the first value and the first time point;
receiving, by the one or more processors, a second value input by a second user at a second time point later than the first time point, and determine a second rating of the performance of the third user using the first value, the first time point, the second value and the second time point; and
determining, by the one or more processors, a difference between the first rating and the second rating, and send a first notification to at least one of the first user, the second user or the third user.

12. The method according to claim 11, wherein determining the second rating comprises:
calculating a plurality of weights corresponding to a plurality of values using a plurality of time points respectively associated with the plurality of values, wherein the plurality of values are input by one or more users and include the first value and the second value, and the weight corresponding to the second value is greater than the weight corresponding to the first value; and
calculating a weighted average of the plurality of values using the plurality of weights.

13. The method according to claim 12, wherein a weight corresponding to a value associated with a time point later than another time point is greater than a weight corresponding to a value associated with the other time point.

14. The method according to claim 12, wherein the plurality of weights has one of a linear weighting scale or an exponential weighting scale.

15. The method according to claim 11, wherein determining the second rating comprises:
determining a plurality of ratings including the first rating and the second rating; and
determining that a number of consecutive ratings, each of which is less than a first threshold, is greater than a second threshold, and send a second notification to at least one of the first user, the second user or the third user.

16. The method according to claim 11, wherein determining the second rating comprises:
determining a plurality of ratings including the first rating and the second rating; and
determining that a number of consecutive ratings, each of which is greater than a third threshold, is greater than a fourth threshold, and send a third notification to at least one of the first user, the second user or the third user.

17. The method according to claim 11, wherein
the first user and the second user are employers, and
the third user is a person employed by at least one of the first user or the second user.

18. The method according to claim 11, wherein
the first user and the second user are persons, and
the third user is an employer of at least one of the first user or the second user.

19. The method according to claim 11, further comprising:
displaying, by a display, a plurality of questions;
for each question, displaying, by the display, options that can be input as an answer to a respective one of the plurality of questions, the options including a first option and a second option;
in response to the plurality of questions being displayed, receiving, by the one or more processors, a number of the first options input by the first user at the first time as answers to the plurality of questions; and
determining, by the one or more processors, the number of the first options as the first value.

20. The method according to claim 19, further comprising:
in response to the plurality of questions being displayed, receiving a number of the first options input by the second user at the second time as answers to the plurality of questions; and
determining the number of the first options as the second value.
